(19) United States
(12) Patent Application Publication
(10) Pub. No.: US 2026/0097750 A1
(43) Pub. Date: Apr. 9, 2026

(54) Modal Impact Hammer and Method for Vibration-Testing a Brake Disc

(71) Applicant: Bayerische Motoren Werke Aktiengesellschaft, Muenchen (DE)

(72) Inventor: Christian BLOCH, Muenchen (DE)

(21) Appl. No.: 19/113,959

(22) PCT Filed: Aug. 25, 2023
(86) PCT No.: PCT/EP2023/073398

§ 371 Date: Mar. 21, 2025

(30) Foreign Application Priority Data
Sep. 23, 2022 (DE) 10 2022 124 548.9

(51) Int. Cl. B60T 17/22; G01H 9/00

(52) U.S. Cl. CPC B60T 17/221; G01H 9/00

(57) ABSTRACT

A modal impact hammer and a method for vibration-testing a brake disc. The method comprises rotating the brake disc while it is meshed with a brake pad, exciting the brake disc by striking it with a vibration-exciter, in particular with a modal impact hammer and/or an electromagnet, and scanning the brake disc at different points with a laser vibrometer.

### BACKGROUND AND SUMMARY

The present disclosure relates to a modal impact hammer and to a method for vibration-testing a brake disk. In particular, the present disclosure relates to an improved option for testing modes of a brake disk under realistic conditions.

Avoiding brake noises is a big challenge for the development of car brake systems. Brake noise test rigs are used to assess the development of noise in the development process of a brake system. A large number of braking actions are replicated under different operating and environmental conditions in order to allow as comprehensive as possible an assessment of the susceptibility of a brake system to make noise (passive noise search).

Alternatively, an active search can be performed in which the brake system is excited by an additional device for creating vibration in the audible frequency range. Reference should be made in this respect to DE 100 06 391 A1 and DE 10 2019 119 149 A1. The excitation of vibration here has to take place as close as possible to the friction contact between the disk and the lining because this is the cause of the brake noise.

The passive noise search is very time-consuming because many experiments are required on the test rig for a conclusive result. Moreover, the results of the passive noise search are subject to fluctuations, the cause of which is not fully understood.

For operational deflection shape analysis of a brake system, a noise must be generated by deliberately initiating the operating states. As soon as a microphone detects the noise, a measurement is made by way of a scanning laser Doppler vibrometer in order to ascertain the operational deflection shapes. It is, however, often difficult to maintain the noise for long enough and the measuring time is thus limited. However, because several hundred measurement points preferably have to be scanned in order to correctly reconstruct an operational deflection shape, there is a need inter alia to initiate the respective operating state multiple times. Moreover, only the operational deflection shape at the frequency of the noise which occurs is measured.

Experimental set-ups known in the prior art have the disadvantage that the brake system of a vehicle is modified sometimes significantly in terms of its vibration behavior by the measuring technology. However, because the additional attachment of small masses (10 g to 50 g) is a known measure for suppressing squeal, the known experimental set-ups are not completely without influence on the test result of the noise behavior of the brake system.

An object of the present disclosure is to obviate the disadvantages known in the prior art.

The abovementioned object is achieved according to the disclosure by a method for vibration-testing a brake disk. In addition, a modal impact hammer is proposed for use in the method according to the disclosure.

According to a first aspect, a method for vibration-testing a brake disk is proposed. The brake disk can be provided for a car brake system. In a first step, the brake disk is rotated whilst it is in engagement with a brake pad or is braked by way of the brake pad. The brake pad or the brake system can also be a brake system which is close to production or corresponds to the production standard. In other words, the vibration properties of a combination of a brake disk and brake pad, brake caliper, etc are tested on a test rig. Engagement of the brake can take place with a predefined braking force. The braked brake disk can be rotated, for example, by way of an electric motor. The speed of the latter can be regulated such that a predefined speed of the brake disk is maintained at all times. In a further step, the brake disk is excited by way of a shaker, in particular automatically, preferably by way of an impact of a modal impact hammer. For this purpose, a modal impact hammer will be referred to below at all times in order to keep the language used simple. In particular, the modal impact hammer can impact the brake disk in a radial direction or in an axial direction. The brake disk is thus excited by way of the modal impact hammer during its movement with a braking force exerted. As a result, a particularly realistic vibration mode for the brake disk results which is made use of subsequently. In a last step, the brake disk is scanned at different points by way of a laser vibrometer. In other words, representative surface regions of the brake disk of the laser vibrometer are scanned in terms of their deflection in the course of the excited vibration (brake squeal). The points can be measured after a single impact by way of the modal impact hammer, by way of a respective impact by the modal impact hammer, or during multiple impacts with the modal impact hammer. Particularly realistic modal analysis results from the rotation with the exertion of a braking force because the excitation and the grinding action by the brake are contained realistically, the local exertion of the brake on different regions of a deflection shape is preserved, centrifugal forces occur within the brake as in actual operation, and additionally ambient air flows through the air chambers between the two sides of the brake disk. The results recorded by the laser vibrometer therefore correspond as best as possible to the actual operating conditions in which brake squeal usually occurs.

The successive measurement of the different points on the brake disk can preferably result in representative results because a predefined speed of the rotation is ensured before the scanning is performed. For example, a speed can be kept constant whilst the scanning is taking place and/or further predefined conditions are ensured. For example, a predefined temperature of the brake disk or the brake fluid can additionally be ensured. For this purpose, the system can be brought into a steady state in which the brake disk radiates the same amount of thermal energy as it absorbs during the braking procedure. The measurement of the predefined temperature can be made by way of contactless measurements, by way of a friction thermocouple and/or by measuring the temperature of the brake fluid. After the brake disk temperature has been stabilized, the measurement by way of the laser vibrometer can be enabled. Alternatively or additionally, a predefined brake pressure can be ascertained which is kept constant over the duration of the scanning of the different points in order to be able to merge the measurement of the different points on the brake disk in an essentially fault-free fashion. Alternatively or additionally, it can be ensured that a predefined rotated position of the brake disk is produced at the moment the modal impact hammer strikes it. In this way, the modal impact hammer always strikes the identical position on the brake disk such that possible rotational asymmetries have no influence on the measurement result. Only once the abovementioned starting conditions or any combinations of the abovementioned starting conditions have been ascertained is the excitation and/or the scanning of the brake disk started. Optimal measurement results can thus be ensured by sequential scanning of the brake disk by way of the laser vibrometer.

During the scanning, the laser beam of the laser vibrometer can follow the movement of a predefined point on the brake disk. For example, the same point can always be irradiated by way of the laser beam during the measurement of the point in question. Alternatively, the laser beam can be oriented fixedly such that a circle is scanned on the brake disk. If the laser beam follows the movement of the measured point, the laser itself can be arranged on a device which is rotated synchronously with the brake disk in order to keep the laser beam directed at the point. Alternatively, the laser beam can be deflected onto a circular path by way of an optical mirror or the like such that one and the same point on the brake disk is scanned at all times, whilst the vibration of the brake disk abates.

The excitation or impact direction of the modal impact hammer can take place in a radial direction and/or in a tangential direction. For example, the modal impact hammer can for this purpose normally excite surfaces of (blank) side faces of the brake disk which are gripped by the brake blocks or the front face, having empty gaps, of the brake disk. The modal impact hammer can here have a handle which is oriented in a tangential direction to the rotation of the brake disk at the moment at which the head of the modal impact hammer touches the brake disk. In this way, torque which may damage the modal impact hammer can be avoided which would possibly excessively stress the mounting of the handle of the modal impact hammer by the brake disk “pulling” the head of the modal impact hammer in a transverse direction at the time of the impact.

The modal impact hammer can be configured to ascertain by way of different measurement sensors a parameter of the impact using measurement technology and to compare it with a predefined reference. In other words, the impulse exerted by the hammer or the speed/acceleration of the hammer head which exists at the time of striking can be ascertained using measurement technology. The reference can represent a target value for the parameter such that, once the predefined reference has been reached, the measurement is declared to be “valid” or “OK” and is stored, whereas, in the event of a deviation from the predefined reference, the measurement is rejected, the measurement data are optionally not stored, and the measurement may automatically be repeated.

The modal impact hammer can in particular be arranged stationarily on the test rig. In particular, the modal impact hammer can be arranged stationarily with respect to the laser vibrometer or the laser vibrometers. For example, the modal impact hammer can be arranged on a stand (tripod) and/or be fixed so that it is at least detached from the brake system in order not to influence the vibration of the brake system during the testing.

The vibration-testing can in particular include the scanning of 3 to 3000, in particular 30 to 300, most preferably 50 to 200, measurement points. Alternatively or additionally, a rotational speed of the brake disk of 0.5 to 10 rpm, preferably of 1 to 5 rpm, most preferably of 1.5 to 4 rpm, can be implemented. These rotational speeds correspond to those which exist shortly before standstill, at which experience has shown that there is the greatest tendency for the brakes to squeal.

The method according to the disclosure can be configured such that at least and preferably exactly one impact is performed by way of the modal impact hammer for each of the abovementioned measurement points on the brake disk, following which the frequency response behavior of the brake disk at the point in question is recorded by way of the laser vibrometer. The surface of the brake disk is thus measured successively point by point by way of the laser vibrometer, after an identical vibration state produced essentially according to the disclosure has been provoked by way of the modal impact hammer.

According to a second aspect of the present disclosure, a modal impact hammer is proposed which is suitable for performing the abovementioned method. The modal impact hammer has a motor by way of which a handle can be pivoted. The handle carries an elastic element between the motor and the head. By virtue of the elastic element, the head is capable of moving slightly at the same time as the brake disk, independently of the kinematics activated by the motor, whilst it is touching the brake disk and is possibly sticking there. As a result, the elastic element relieves the strain on the mounting of the handle in the motor or on the motor, decouples the motor in terms of vibration from the head, and can, by being deformed, also provide information about the forces which are acting. In other words, the elastic element allows displacement measurement in order to be able to deduce the impact force.

In particular, the elastic element can be arranged between the motor and the handle and/or between the handle and the head of the modal impact hammer. Particularly efficient decoupling, simple assembly, and a long lifetime can thus be obtained. In particular where the elastic element is arranged with respect to the handle and the head, the handle and the head can be configured in such a way that the elastic element assumes a form fit both with the handle and the head. This form fit can be produced, for example, by a first thread (internal thread in the elastic element) and an external thread on the outer surface of the elastic element. The internal thread of the elastic element engages in an external thread in the handle, whereas an internal thread of the head engages in the external thread in the elastic element. A permanent connection to the head and the handle can thus be produced by way of the elastic element.

### BRIEF DESCRIPTION OF THE DRAWINGS

Further details, features, and advantages of the disclosure can be found in the following description and the Figures.

FIG. 1 shows a perspective illustration of an experimental set-up for performing a method according to the disclosure; and,

FIG. 2 shows a flow diagram illustrating steps of an exemplary embodiment of a method according to the disclosure for vibration-testing a brake disk.

### DETAILED DESCRIPTION OF THE DRAWINGS

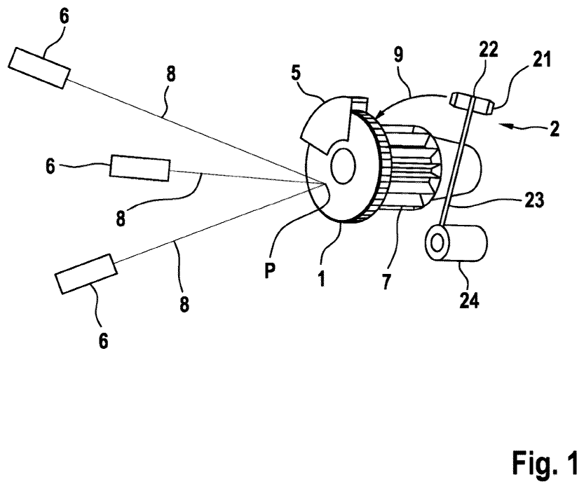

An experimental set-up in which an electric motor 7 is capable of rotating a brake disk 1 of a brake system at a constant rotational speed is illustrated in FIG. 1. A brake caliper 5 with a brake pad (not illustrated) is configured to brake the rotation during the rotation of the brake disk 1. To do this, the brake caliper 5 presses a brake pad (not illustrated) against the friction ring of the brake disk 1 by way of a brake piston (not illustrated). A modal impact hammer 2 is configured to be guided in the direction of an arrow 9 against a front face of the brake disk 1 by an electric motor 24 which is capable of pivoting a handle 23. The head 21, coupled to the handle 23 via a rubber sleeve as an elastic element 22, here collides with the front face and excites the brake disk 1 during the braked rotation to cause vibration. A point P is scanned via laser beams 8 by way of a laser vibrometer 6. As a result, the deflection shape of the brake disk 1 can be measured at least with respect to the circle lying on the corresponding radius.

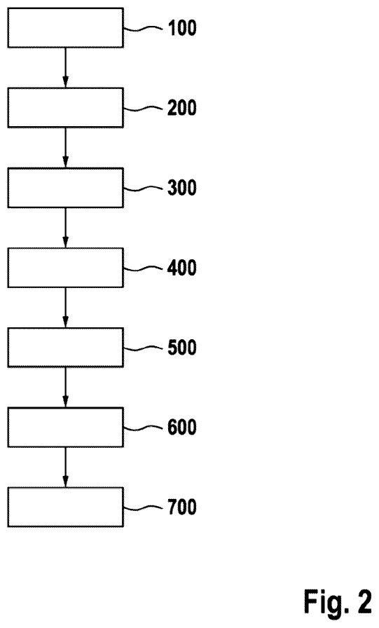

FIG. 2 shows steps of an exemplary embodiment of a method according to the disclosure for vibration-testing a brake disk. In step 100, the brake disk is rotated in the braked state. Before the measurement begins, in step 200 the presence of a predefined speed of the rotation (rotational speed) is ascertained, in step 300 a predefined temperature of the brake system (for example, of the brake fluid) is ascertained, in step 400 a predefined brake pressure is established, and in step 500 a predefined rotated position of the brake disk is ascertained. In response thereto, the excitation of the brake disk is performed in step 600 by way of an impact of a modal impact hammer. The modal impact hammer hereby excites the brake disk over a wide frequency band whilst it is being rotated, braked, by an electric motor. Finally, in step 700 the brake disk is scanned at different points by way of a laser vibrometer. After the impact made in step 600, at least a point or a circular path on the brake disk is scanned by way of the laser vibrometer. A new impact by way of the modal impact hammer can in each case be made for the scanning in step 700 with respect to further points.

As an alternative to the modal impact hammer, the housing of the electromagnet is mounted with no direct contact with the brake system. The electromagnet generates via the friction ring of the brake disk a highly dynamic magnetic field by way of which the brake system can be excited over a wide frequency band to cause vibration.

This type of vibration analysis is usually carried out on static objects or systems. In the novel method, however, the vibration of the brake is excited by the modal impact hammer or the electromagnet during the operation of the brake system in order to ascertain the system properties during the operation of the brake system. To do this, the modal impact hammer impacts the rotating friction ring at a constant speed of the friction ring and a constant brake pressure. If the electromagnet is fitted, the highly dynamic magnetic field sets the rotating friction ring in motion by magnetic interaction.

By virtue of the external excitation during braking, even in the absence of the explicit occurrence of a noise, the susceptibility of the brake system to make noise over the whole spectrum can be detected. To do this, a transmission function between the surface velocity of multiple points on the brake disk and the brake lining, and an excitation force applied by the modal impact hammer or the electromagnet is formed. The surface velocity is detected contactlessly, for example with a scanning laser Doppler vibrometer. Both the in-plane and out-of-plane movement of the components must be detected. The transmission function is used to assess critical frequencies of the brake system. The more critical a certain frequency is in terms of squeal, the greater the amplitude of the transmission function at the respective frequency.

The susceptibility of a brake system to make noise can be assessed quickly over the whole frequency range by way of the novel method. The method is therefore less time-consuming. Moreover, the results of the active noise search are less subject to fluctuations such that the method is reproducible.

In addition to ascertaining the modal parameters, the external excitation during the operation additionally allows the operational deflection shapes of the brake system to be measured. The controlled external excitation over a wide frequency range by way of the modal impact hammer or the electromagnetic shaker allows continuous measurement of many operational deflection shapes over the whole frequency range without a noise actually having to occur.

Reactionless testing of the susceptibility of the brake system to make noise is possible with the modal impact hammer or the electromagnet because the housing of the modal impact hammer or the electromagnet is mounted with no direct contact with the brake system. Moreover, the use of the modal impact hammer or the electromagnet is a particularly simple form of excitation for exciting the rotated brake disk, braked, over a wide frequency range and modifications which change the vibration behavior of the brake system can be dispensed with. Overall, there is a cost saving and the quality of the measurement results is increased.

The method described herein may be carried out in whole or in part via a suitable control unit (e.g., a processor) configured to executed software, instructions, and/or logic stored in a memory.

### LIST OF REFERENCE SIGNS

1 brake disk
2 modal impact hammer
5 brake caliper
6 laser vibrometer
7 electric motor
8 laser beam
9 arrow
21 head
22 elastic element
23 handle
24 electric motor
100 to 700 method steps
P points

1.-10. (canceled)

11. A method for vibration-testing a brake disk comprising:
rotating the brake disk whilst the latter is in engagement with a brake pad,
exciting the brake disk by way of an impact of a modal impact hammer and/or an electromagnet, and
scanning the brake disk at different points by way of a laser vibrometer.

12. The method according to claim 11, further comprising:
ascertaining a predefined speed of the rotation, and/or
ascertaining a predefined temperature, and/or
ascertaining a predefined brake pressure, and/or
ascertaining a predefined rotated position of the brake disk, and
in response thereto, starting the excitation and/or the scanning.

13. The method according to claim 11, wherein, during the scanning, a laser beam of the laser vibrometer:
follows the movement of a point on the brake disk or
is oriented fixedly.

14. The method according to claim 11, wherein the excitation takes place in a radial direction and/or in a tangential direction.

15. The method according to claim 11, wherein a handle of the modal impact hammer is oriented tangentially to the rotation of the brake disk.

16. The method according to claim 11, wherein furthermore a parameter of the impact is ascertained using measurement technology and compared with a predefined reference, wherein, in response to reaching the predefined reference, the measurement is declared to be OK and is stored, but, in the event of a deviation from the predefined reference, the measurement is rejected, and is automatically repeated.

17. The method according to claim 11, wherein the vibration-testing:
includes three to 3000 points and/or
is implemented at a rotational speed of the brake disk of 0.5 to 10 rpm.

18. The method according claim 17, wherein at least one impact is performed by way of the modal impact hammer for each of the points.

19. A modal impact hammer comprising:
a motor,
a handle,
an elastic element, and
a head, wherein the elastic element is arranged between the motor and the head.

20. The modal impact hammer as claimed in claim 19, wherein the elastic element is arranged
between the motor and the handle, and/or
between the handle and the head.
